(19) United States
(12) Patent Application Publication
(10) Pub. No.: US 2009/0147538 A1
(43) Pub. Date: Jun. 11, 2009

(54) LIGHT GUIDE PLATE WITH LASER PROCESS PATTERNS ON AN INCIDENT PLANE AND MANUFACTURING METHOD THEREOF

(76) Inventors: Tzu-Wei Wang, Taoyuan County (TW); Jan-Min Huang, Hsinchu City (TW); Ching-Hung Chen, Taoyuan County (TW); Tzeng-Guang Tsai, Hsinchu City (TW); Min-Xian Lin, Miaoli County (TW); Chen-Hua Huang, Taipei City (TW); Feng-Lung Luo, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/951,333

(22) Filed: Dec. 6, 2007

(51) Int. Cl. F21V 8/00; B29D 11/00

(52) U.S. Cl. 362/621; 216/24

(57) ABSTRACT

A method for patterning a light guide plate includes: (a) using laser beams to carve out a plurality of notches on a mold; and (b) manufacturing the light guide plate with the mold for forming a plurality of laser process patterns on an incident plane of the light guide plate.

### BACKGROUND OF THE INVENTION

1. Field of the Invention

The present invention relates to a light guide plate and a manufacturing method thereof, and more particularly, to a light guide plate with laser process patterns on an incident plane and a manufacturing method thereof.

2. Description of the Prior Art

Backlight units are known in the art. The backlight unit, which is a key element in the fabrication of liquid crystal displays (LCDs), is widely used in monitors, notebooks, digital cameras, projectors and so on. Backlight units are typically divided into two major categories: edge-type and direct-type, wherein a light source of the edge-type backlight unit is positioned on the lateral side of the display panel so as to reduce the size and cost of the liquid crystal display.

Please refer to FIG. 1. FIG. 1 is a diagram of an edge-type backlight module 10 in the prior art. The edge-type backlight module 10 is disposed below a display panel 12. The edge-type backlight module 10 includes a light guide plate 14 installed below the display panel 12, a plurality of light sources 16 installed on a lateral side of the light guide plate 14, which can be light emitting diodes (LED), a light cover 18 installed outside the light sources 16, a reflecting sheet 20 installed below the light guide plate 14 for reflecting light emitted through the light guide plate 14 downward back to the light guide plate 14, and an optical material layer 22 installed between the light guide plate 14 and the display panel 12. The light source 16 can emit light to the display panel 12, and the light cover 18 and the reflecting sheet 20 can reflect the light emitted from the light sources 16 to the light guide plate 14 so as to increase a light utility rate. Micro-scattering points positioned on the bottom of the light guide plate 14 can interfere with the total reflection of light inside the light guide plate 14 so that the light can be refracted outside the light guide plate 14 and into the optical material layer 22. The optical material layer 22 can mist and focus the light refracted from the light guide plate 14 for providing light to the display panel 12.

As described above, the light guide plate 14 is one of the important parts of the edge-type backlight module 10. The light guide plate 14 guides the light uniformly in order to increase the luminance of the display panel 12 and to ensure the uniformity of brightness in the display panel 12. Conventional methods for patterning the light guide plate 14 can be divided into two types according to the manufacturing process. The first one is a screen printing method which utilizes materials with a high reflection ratio and non-absorbance characteristics on an acrylic plate to form circular or rectangular patterns on the light guide plate 14. The second one is to form a patterned light guide plate 14 directly by injection molding as shown in FIG. 2. FIG. 2 shows a conventional injection molding of the light guide plate 14. First, a patterned metal film 24 is attached to a female mold (or mirror mold) 26. A male mold 28 and the female mold 26 are then assembled together. A material to form the light guide plate 14 (typically propylene, also known as acrylic) is then injected along the direction shown by the arrow from an injection spout of the male mold 28 into a mold cavity 30. The pattern is transcripted onto the acrylic plate by an injector or a hot press. The pattern of the light guide plate 14 can be formed on the patterned metal film 24 by a cutter, a lathe, a linear cut method, a sand-blasting method, an etching method, and so on.

The pattern of the light guide plate 14 is formed on the patterned metal film by a sand blasting method, an etching method, or a cutting method in the prior art. However, the cutting method has disadvantages of worn cost, long manufacturing period, poor precision, and lack of variety of the patterns. Furthermore, the sand blasting method and the etching method are difficult to reproduce, causing distortion of the pattern and causing the distortion bias of the light distribution to occur. In addition, the prior art method is not very precise at controlling the density of the patterns on the light guide plate by adjusting the roughness distribution of the sand-blasting surface. Hence the prior art cannot reliably fabricate the sand-blasting mist surface with the same roughness. This creates a problem in adjusting the light uniformly of the backlight module.

### SUMMARY OF THE INVENTION

It is therefore a primary objective of the claimed invention to provide a light guide plate with laser process patterns on an incident plane and a manufacturing method thereof for solving the above-mentioned problem.

According to the claimed invention, a method for patterning a light guide plate includes: (a) using laser beams to carve out a plurality of notches on a mold; and (b) manufacturing the light guide plate with the mold for forming a plurality of laser process patterns on an incident plane of the light guide plate.

According to the claimed invention, an edge-light backlight module includes a light source, and a light guide plate installed on a lateral side of the light source. The light guide plate includes an incident plane for guiding light emitted from the light source inside the light guide plate. The plurality of laser process patterns is on the incident plane. The light guide plate further includes a light-exit plane for guiding the light emitted from the light source out of the light guide plate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an edge-type backlight module in the prior art.

FIG. 2 shows a conventional injection molding of a light guide plate.

FIG. 3 is a diagram of an edge-type backlight module according to a preferred embodiment of the present invention.

FIG. 4 is a perspective drawing of a light guide plate according to the preferred embodiment of the present invention.

FIG. 5 is a lateral view of the light guide plate according to the preferred embodiment of the present invention.

FIG. 6 is a flowchart of manufacturing the light guide plate according to the preferred embodiment of the present invention.

FIG. 7 to FIG. 9 are diagrams of laser process patterns in different types according to the embodiments of the present invention.

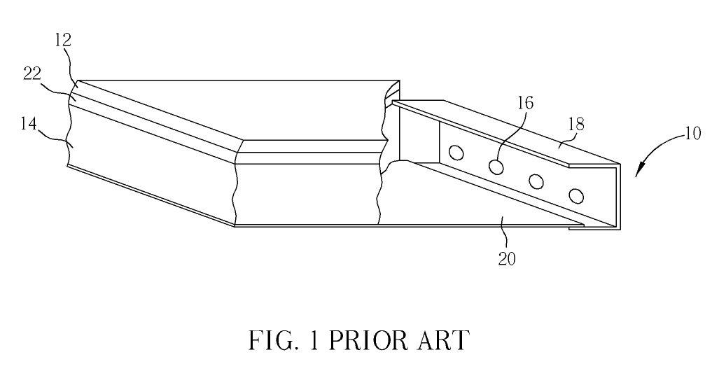

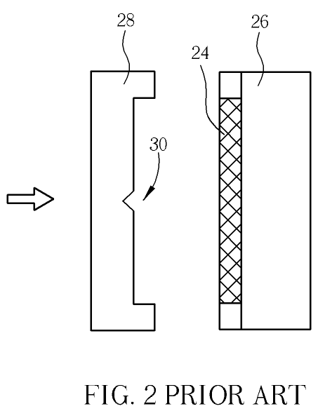

### DETAILED DESCRIPTION

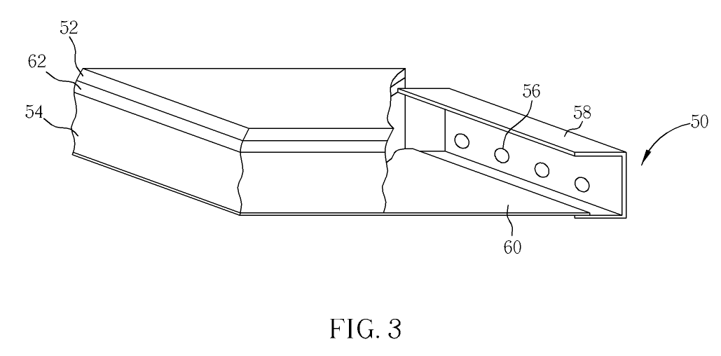

Please refer to FIG. 3. FIG. 3 is a diagram of an edge-type backlight module 50 according to a preferred embodiment of the present invention. The edge-type backlight module 50 is disposed below a display panel 52. The edge-type backlight module 50 includes a light guide plate 54 installed below the display panel 52, a plurality of light sources 56 installed on a lateral side of the light guide plate 54, which can be light emitting diodes (LED), a light cover 58 installed outside the light sources 56, a reflecting sheet 60 installed below the light guide plate 54 for reflecting light emitted through the light guide plate 54 downward back to the light guide plate 54, and an optical material layer 62 installed between the light guide plate 54 and the display panel 52. The light source 56 can emit light to the display panel 52, and the light cover 58 and the reflecting sheet 60 can reflect the light emitted from the light sources 56 to the light guide plate 54 so as to increase a light utility rate. The light guide plate 54 can be an acrylic plate. The optical material layer 62 can include optical prisms. The optical material layer 62 mists and focuses the light refracted from the light guide plate 54 for providing uniform and concentrated light to the display panel 52.

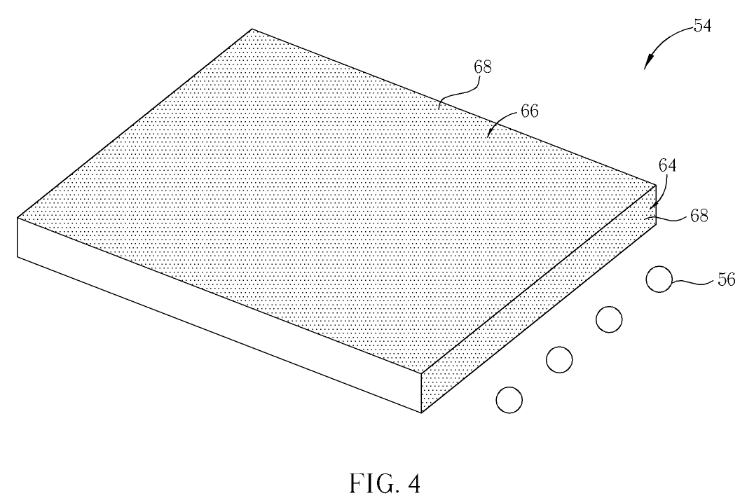

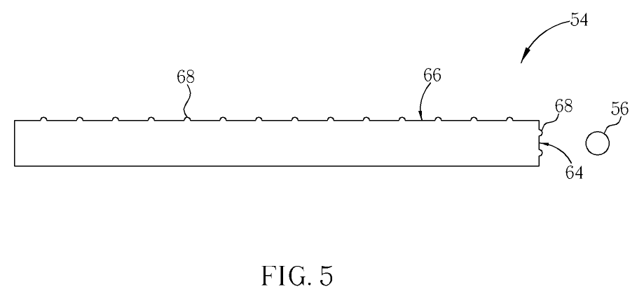

Please refer to FIG. 3, FIG. 4, and FIG. 5. FIG. 4 is a perspective drawing of the light guide plate 54 according to the preferred embodiment of the present invention. FIG. 5 is a lateral view of the light guide plate 54 according to the preferred embodiment of the present invention. The light guide plate 54 includes an incident plane 64 for guiding light emitted from the light source 56 inside the light guide plate 54, and a light-exit plane 66 for guiding the light emitted from the light source 56 to the optical material layer 62 above the light guide plate 54. The optical material layer 62 can mist and focus the light refracted from the light guide plate 54 for providing uniform and concentrated light to the display panel 52. The light guide plate 54 further includes a plurality of laser process patterns 68 on the incident plane 64 and the light-exit plane 66. The laser process pattern 68 can be a volcano structure or a spherical structure. The plurality of laser process patterns 68 can be formed in an array or linearly. The plurality of laser process patterns 68 is disposed on the light-exit plane 66 optionally for scattering light to the optical material layer 62. The plurality of laser process patterns 68 disposed on the incident plane 64 is to enhance uniformity of brightness of the incident side of the light guide plate 54 and to reduce light arcs so as to improve a light mixing effect and to reduce a light mixing distance.

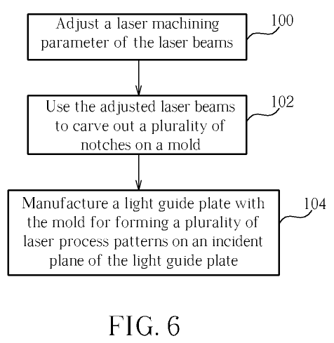

Please refer to FIG. 6. FIG. 6 is a flowchart of manufacturing the light guide plate 54 according to the preferred embodiment of the present invention. The present invention includes following steps:

Step 100: Adjust a laser machining parameter of the laser beams.

Step 102: Use the adjusted laser beams to carve out a plurality of notches on a mold.

Step 104: Manufacture the light guide plate 54 with the mold for forming the plurality of laser process patterns 68 on the incident plane 64 of the light guide plate 54.

More detailed descriptions for the steps mentioned above will be provided. First, the laser machining parameter of the laser beams can be adjusted, such as intensity, frequency, and a number of strikes, so as to control density or hollowness of the plurality of notches on the mold. The laser beams can be Nd-YAG laser beams used for hitting the surface of the mold so as to form the plurality of notches on the mold. The mold can be made of steel or acrylic, such as SUS, STAVAX, and so on. The energy of the laser beams can fuse the surface of the mold so as to form spherical cavities where the laser beams hit due to the cohesion and the surface tension of the material of the mold. Next the light guide plate 54 can be manufactured with the mold as a female mold by injection molding or a thermoforming method, and the laser process patterns 68 of the light guide plate 54 are located in positions corresponding to the cavities where the laser beams hit.

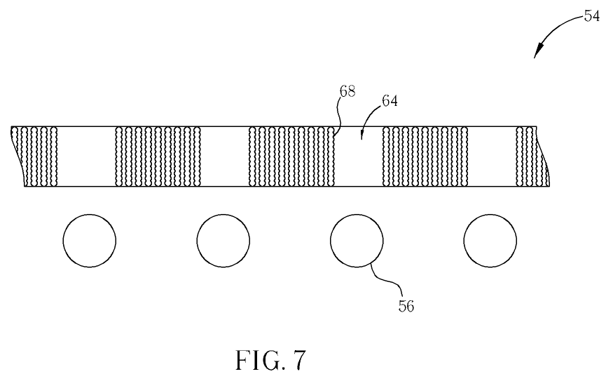

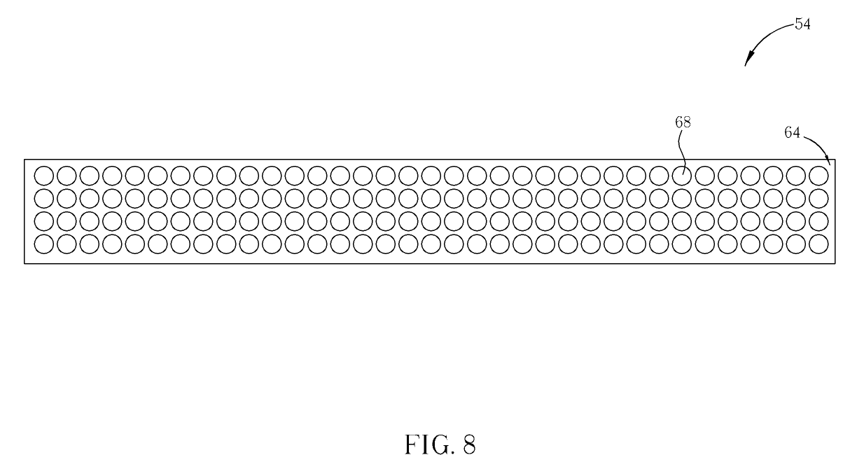

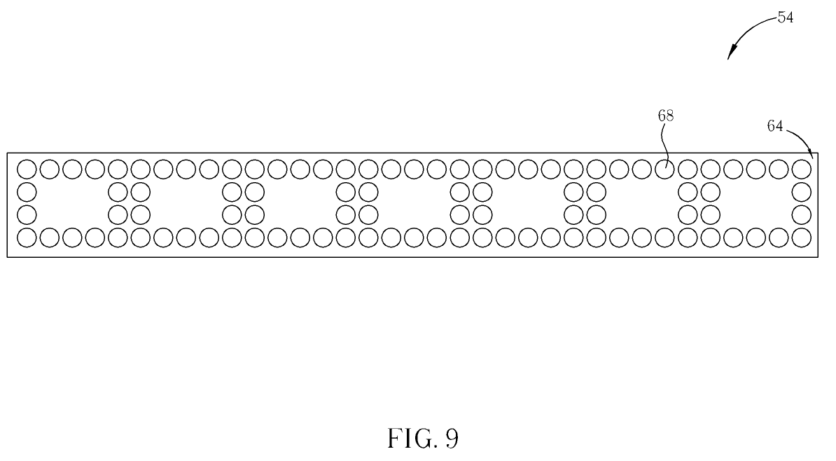

The laser process patterns 68 on the incident plane 64 of the light guide plate 54 can be spaced at intervals. Please refer to FIG. 7 to FIG. 9. FIG. 7 to FIG. 9 are diagrams of the laser process patterns 68 in different types according to the embodiments of the present invention. The laser process patterns 68 can be arranged regularly or irregularly, For example, the laser process patterns 68 can be disposed on positions between the LED light sources 56 on the incident plane 64 of the light guide plate 54 so as to scatter the light emitted from the light sources 56 inside the light guide plate 54 efficiently for reducing light mixing distances between the LED light sources 56 and preventing dark dots between the light sources. It also can reduce the usage number of LED light sources 56. In addition, the bright and dark sections are adjusted so as to increase light-emitting efficiency of the light guide plate 54 and to enlarge a viewable range of the display panel 52.

In contrast to the light guide plate and the manufacturing method thereof in the prior art, the laser process patterns on the incident plane of the light guide plate can be manufactured with the mold processed by the laser beams so as to increase light-emitting efficiency. The present invention has advantages of short process period, low cost, variety of the patterns, and high precision. It not only can avoid worn cost of cutters due to non-contact process of laser beams but also reduce light arcs so as to improve a light mixing effect and to reduce a light mixing distance. Additionally, it is easy to reproduce due to the mold processed by the laser beams precisely. In conclusion, the present invention can increase light-emitting efficiency and quality of the light guide plate and reduce manufacturing cost of the light guide plate for promoting market power and increasing benefit of products.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for patterning a light guide plate comprising:
(a) using laser beams to carve out a plurality of notches on a mold; and
(b) manufacturing the light guide plate with the mold for forming a plurality of laser process patterns on an incident plane of the light guide plate.

2. The method of claim 1 further comprising adjusting a laser machining parameter for controlling density of the plurality of notches on the mold.

3. The method of claim 1 further comprising adjusting a laser machining parameter for controlling hollowness of the plurality of notches on the mold.

4. The method of claim 1 wherein step (b) comprises manufacturing the light guide plate with the mold by injection molding.

5. The method of claim 1 wherein step (b) comprises manufacturing the light guide plate with the mold in a thermoforming method.

6. The method of claim 1 wherein the mold is made of stainless steel.

7. An edge-light backlight module comprising:
a light source; and
a light guide plate installed on a lateral side of the light source, the light guide plate comprising:
an incident plane for guiding light emitted from the light source inside the light guide plate, a plurality of laser process patterns being on the incident plane; and
a light-exit plane for guiding the light emitted from the light source out of the light guide plate.

8. The edge-light backlight module of claim 7 wherein the light guide plate is an acrylic plate.

9. The edge-light backlight module of claim 7 wherein the laser process pattern is a volcano structure.

10. The edge-light backlight module of claim 7 wherein the laser process pattern is a spherical structure.

11. The edge-light backlight module of claim 7 wherein the plurality of laser process patterns is formed in an array.

12. The edge-light backlight module of claim 7 wherein the plurality of laser process patterns is formed linearly.

13. The edge-light backlight module of claim 7 wherein the plurality of laser process patterns is formed with a laser process mold by injection molding.

14. The edge-light backlight module of claim 7 further comprising an optical material layer disposed above the light guide plate for misting and focusing the light refracted from the light-exit plane.

15. The edge-light backlight module of claim 7 wherein the light source is a light emitting diode.
